(19) United States
(12) Patent Application Publication
(10) Pub. No.: US 2024/0178459 A1
(43) Pub. Date: May 30, 2024

(54) SOLID-STATE BATTERY AND METHOD OF MANUFACTURING SAME

(71) Applicant: HONDA MOTOR CO., LTD., Tokyo (JP)

(72) Inventors: Toshimitsu TANAKA, Saitama (JP); Takuya TANIUCHI, Saitama (JP)

(21) Appl. No.: 18/492,796

(22) Filed: Oct. 24, 2023

(30) Foreign Application Priority Data
Nov. 30, 2022 (JP) 2022-191135

(51) Int. Cl. H01M 10/0587; H01M 4/36; H01M 10/052; H01M 50/403; H01M 50/44

(52) U.S. Cl. CPC H01M 10/0587; H01M 4/364; H01M 10/052; H01M 50/403; H01M 50/44

(57) ABSTRACT

Provided is a solid-state battery including: an electrode laminate in which a first electrode mixture layer, a solid electrolyte layer, a second electrode mixture layer, and a second fixing member are sequentially laminated over a first fixing member; a first guide member disposed along an outer periphery of the first electrode mixture layer; and a second guide member disposed along an outer periphery of the second electrode mixture layer. The first guide member is bonded to the solid electrolyte layer and/or the first fixing member, and the second guide member is bonded to the solid electrolyte layer and/or the second fixing member.

This application is based on and claims the benefit of priority from Japanese Patent Application 2022-191135, filed on 30 Nov. 2022, the content of which is incorporated herein by reference.

### BACKGROUND OF THE INVENTION

### Field of the Invention

The present invention relates to a solid-state battery and a method of manufacturing the solid-state battery.

### Related Art

In recent years, research and development of secondary batteries that contribute to energy efficiency has been carried out in order to ensure many people have access to reasonable, reliable, sustainable, and advanced energy.

Known examples of the secondary battery include a solid-state battery including an electrode laminate in which a positive electrode mixture layer, a solid electrolyte layer, and a negative electrode mixture layer are sequentially laminated.

Patent Document 1 discloses a method of manufacturing an all-solid-state battery in which a positive electrode and negative electrodes each having a larger area than the positive electrode are laminated via solid electrolyte layers. Specifically, an insulator having a thickness equal to or less than the thickness of the positive electrode is disposed along the outer periphery of the positive electrode in a part of a gap between the negative electrodes such that a clearance is provided between the positive electrode and the insulator. The solid electrolyte layers are interposed between the positive electrode including the insulator and the negative electrodes, and the resultant laminate is pressed at both surfaces thereof.
Patent Document 1: Japanese Unexamined Patent Application, Publication No. 2015-162353

### SUMMARY OF THE INVENTION

However, the electrodes (the positive electrode and the negative electrodes) extend and are displaced during the process for manufacturing the all-solid-state battery. As a result, a short circuit may occur, or cracking and wrinkles may occur in the constituent members. Furthermore, in a case of using a stack of electrode laminates each including a positive electrode and a negative electrode laminated with a solid electrolyte layer interposed therebetween, since the current collectors are in contact with each other, stack displacement can be caused by vibration, collisions, and other factors.

It is an object of the present invention to provide a solid-state battery in which the extension of electrodes and the occurrence of displacement are reduced during the manufacturing process, and which is capable of preventing or reducing the occurrence of stack displacement even in the case of using a stack of electrode laminates.

A first aspect of the present invention is directed to a solid-state battery including: an electrode laminate in which a first electrode mixture layer, a solid electrolyte layer, a second electrode mixture layer, and a second fixing member are sequentially laminated over a first fixing member; a first guide member disposed along an outer periphery of the first electrode mixture layer; and a second guide member disposed along an outer periphery of the second electrode mixture layer. The first guide member is bonded to the solid electrolyte layer and/or the first fixing member, and the second guide member is bonded to the solid electrolyte layer and/or the second fixing member.

A second aspect of the present invention is an embodiment of the first aspect. In the solid-state battery according to the second aspect, at least one of the solid electrolyte layer, the first fixing member, the second fixing member, the first guide member, or the second guide member includes a nonwoven fabric. A content of the nonwoven fabric in the solid electrolyte layer is equal to or less than a content of the nonwoven fabric in the first fixing member, equal to or less than a content of the nonwoven fabric in the second fixing member, equal to or less than a content of the nonwoven fabric in the first guide member, and equal to or less than a content of the nonwoven fabric in the second guide member. An average fiber diameter of the nonwoven fabric in the solid electrolyte layer is equal to or less than an average fiber diameter of the nonwoven fabric in the first fixing member, equal to or less than an average fiber diameter of the nonwoven fabric in the second fixing member, equal to or less than an average fiber diameter of the nonwoven fabric in the first guide member, and equal to or less than an average fiber diameter of the nonwoven fabric in the second guide member.

A third aspect of the present invention is an embodiment of the first aspect. In the solid-state battery according to the third aspect, the solid electrolyte layer, the first fixing member, the second fixing member, the first guide member, and the second guide member each include a binder. A content of the binder in the solid electrolyte layer is equal to or less than a content of the binder in the first fixing member, equal to or less than a content of the binder in the second fixing member, equal to or less than a content of the binder in the first guide member, and equal to or less than a content of the binder in the second guide member.

A fourth aspect of the present invention is an embodiment of the first aspect. In the solid-state battery according to the fourth aspect, the first electrode mixture layer and the second electrode mixture layer are a positive electrode mixture layer and a negative electrode mixture layer, respectively. The second guide member is an elastic member, and each of the first fixing member, the second fixing member, and the first guide member is an elastic member having a higher Young's modulus than the second guide member.

A fifth aspect of the present invention is directed to a method of manufacturing the solid-state battery according to any of the first to fourth aspects. The method according to the fifth aspect includes: a first disposing step of disposing the first guide member on the first fixing member; a second disposing step of disposing the first electrode mixture layer over a region of the first fixing member where the first guide member is not disposed; a third disposing step of disposing the solid electrolyte layer on the first guide member and the first electrode mixture layer; a fourth disposing step of disposing the second guide member on the solid electrolyte layer; a fifth disposing step of disposing the second electrode mixture layer over a region of the solid electrolyte layer where the second guide member is not disposed; a sixth disposing step of disposing the second fixing member on the second guide member and the second electrode mixture layer; and a bonding step of bonding the first guide member to the solid electrolyte layer and/or the first fixing member and bonding the second guide member to the solid electrolyte layer and/or the second fixing member.

A sixth aspect of the present invention is an embodiment of the fifth aspect. The method according to the sixth aspect further includes a temporary bonding step of temporarily bonding the first fixing member to the first guide member, between the first disposing step and the second disposing step.

A seventh aspect of the present invention is an embodiment of the fifth or sixth aspect. The method according to the seventh aspect further includes a temporary bonding step of temporarily bonding the first guide member to the solid electrolyte layer, between the third disposing step and the fourth disposing step.

An eighth aspect of the present invention is an embodiment of any of one of the fifth to seventh aspects. The method according to the eighth aspect further includes a temporary bonding step of temporarily bonding the solid electrolyte layer to the second guide member, between the fourth disposing step and the fifth disposing step.

The present invention provides a solid-state battery in which the extension of electrodes and the occurrence of displacement are reduced during the manufacturing process, and which is capable of preventing or reducing the occurrence of stack displacement even in the case of using a stack of electrode laminates.

### BRIEF DESCRIPTION OF THE DRAWINGS

FIG. 1 is a cross-sectional view illustrating an example of a solid-state battery according to an embodiment;

FIG. 2 is a cross-sectional view illustrating a modification of the solid-state battery of FIG. 1;

FIG. 3 is a cross-sectional view illustrating another example of the solid-state battery according to the embodiment;

FIG. 4 is a cross-sectional view illustrating a modification of the solid-state battery of FIG. 3;

FIG. 5 is a cross-sectional view illustrating another example of the solid-state battery according to the embodiment;

FIGS. 6A, 6B, 6C, and 6D are top views (Part 1) illustrating an example of a method of manufacturing the solid-state battery according to the embodiment; and

FIGS. 7A, 7B, 7C, and 7D are top views (Part 2) illustrating the example of the method of manufacturing the solid-state battery according to the embodiment.

### DETAILED DESCRIPTION OF THE INVENTION

Embodiments of the present invention will be described with reference to the accompanying drawings.

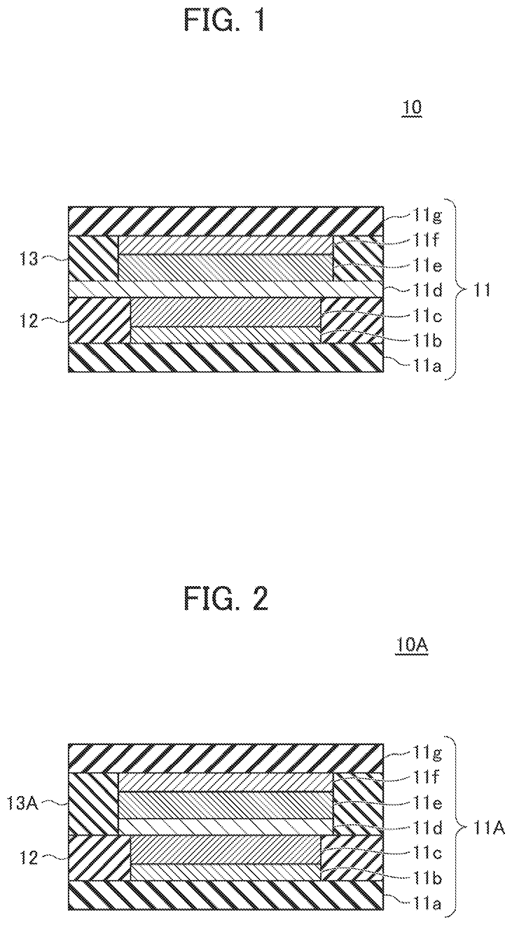

FIG. 1 illustrates an example of a solid-state battery according to the present embodiment.

The solid-state battery 10 includes an electrode laminate 11 in which a positive electrode current collector 11b, a positive electrode mixture layer 11c as a first electrode mixture layer, a solid electrolyte layer 11d, a negative electrode mixture layer 11e as a second electrode mixture layer, a negative electrode current collector 11f, and a second fixing member 11g are sequentially laminated over a first fixing member 11a. Due to this configuration, even in a case of using a stack of the electrode laminates 11, the occurrence of stack displacement is prevented or reduced. Here, a first guide member 12 is disposed along an outer periphery of the positive electrode current collector 11b and an outer periphery of the positive electrode mixture layer 11c. Furthermore, a second guide member 13 is disposed along an outer periphery of the negative electrode mixture layer 11e and an outer periphery of the negative electrode current collector 11f. The solid electrolyte layer 11d is interposed between the first guide member 12 and the second guide member 13. Since the first guide member 12 is bonded to the first fixing member 11a and the solid electrolyte layer 11d, extension and displacement of the positive electrode (the positive electrode current collector 11b and the positive electrode mixture layer 11c) are prevented or reduced during the process for manufacturing the solid-state battery 10. Moreover, since the second guide member 13 is bonded to the solid electrolyte layer 11d and the second fixing member 11g, extension and displacement of the negative electrode (the negative electrode current collector 11f and the negative electrode mixture layer 11e) are prevented or reduced during the process for manufacturing the solid-state battery 10.

In a case where the negative electrode mixture layer 11e is a lithium metal layer, the negative electrode mixture layer 11e does not have to exist in an initial state. That is, the solid-state battery 10 may be configured as an anode-free battery.

Materials forming the first fixing member 11a, the second fixing member 11g, the first guide member 12, and the second guide member 13 are not particularly limited as long as they have no electron conductivity, and examples of the materials include a binder such as rubber and urethane resin, a nonwoven fabric, a solid electrolyte, etc.

In a case where the solid electrolyte layer 11d, the first fixing member 11a, the second fixing member 11g, the first guide member 12, and the second guide member 13 each include a nonwoven fabric, it is preferable that a content of the nonwoven fabric in the solid electrolyte layer 11d is equal to or less than a content of the nonwoven fabric in the first fixing member 11a, equal to or less than a content of the nonwoven fabric in the second fixing member 11g, equal to or less than a content of the nonwoven fabric in the first guide member 12, and equal to or less than a content of the nonwoven fabric in the second guide member 13. It is preferable that an average fiber diameter of the nonwoven fabric in the solid electrolyte layer 11d is equal to or less than an average fiber diameter of the nonwoven fabric in the first fixing member 11a, equal to or less than an average fiber diameter of the nonwoven fabric in the second fixing member 11g, equal to or less than an average fiber diameter of the nonwoven fabric in the first guide member 12, and equal to or less than an average fiber diameter of the nonwoven fabric in the second guide member 13. This configuration allows each of the first fixing member 11a, the second fixing member 11g, the first guide member 12, and the second guide member 13 to have a strength equal to or greater than that of the solid electrolyte layer 11d.

In a case where the solid electrolyte layer 11d, the first fixing member 11a, the second fixing member 11g, the first guide member 12, and the second guide member 13 each contain a binder, it is preferable that a content of the binder in the solid electrolyte layer 11d is equal to or less than a content of the binder in the first fixing member 11a, equal to or less than a content of the binder in the second fixing member 11g, equal to or less than a content of the binder in the first guide member 12, and equal to or less than a content of the binder in the second guide member 13. This configuration allows each of the first fixing member 11a, the second fixing member 11g, the first guide member 12, and the second guide member 13 to have a strength equal to or greater than that of the solid electrolyte layer 11d.

The solid electrolyte layer 11d, the first fixing member 11a, the second fixing member 11g, the first guide member 12, and the second guide member 13 may be made of different materials, but are preferably made of the same material. In the latter case, a bonding strength between the first guide member 12 and the first fixing member 11a and the solid electrolyte layer 11d and a bonding strength between the second guide member 13 and the solid electrolyte layer 11d and the second fixing member 11g are improved, so that displacement of the positive electrode mixture layer 11c and the negative electrode mixture layer 11e is prevented or reduced during the process for manufacturing the solid-state battery 10.

FIG. 2 illustrates a modification of the solid-state battery 10.

The solid-state battery 10A has the same configuration as that of the solid-state battery 10 except that in an electrode laminate 11A, a solid electrolyte layer 11d is not interposed between a first guide member 12 and a second guide member 13A. Specifically, the second guide member 13A is disposed along an outer periphery of a solid electrolyte layer 11d, an outer periphery of a negative electrode mixture layer 11e, and an outer periphery of a negative electrode current collector 11f. The first guide member 12 is bonded to a first fixing member 11a and the second guide member 13A, and the second guide member 13A is bonded to a second fixing member 11g and the first guide member 12.

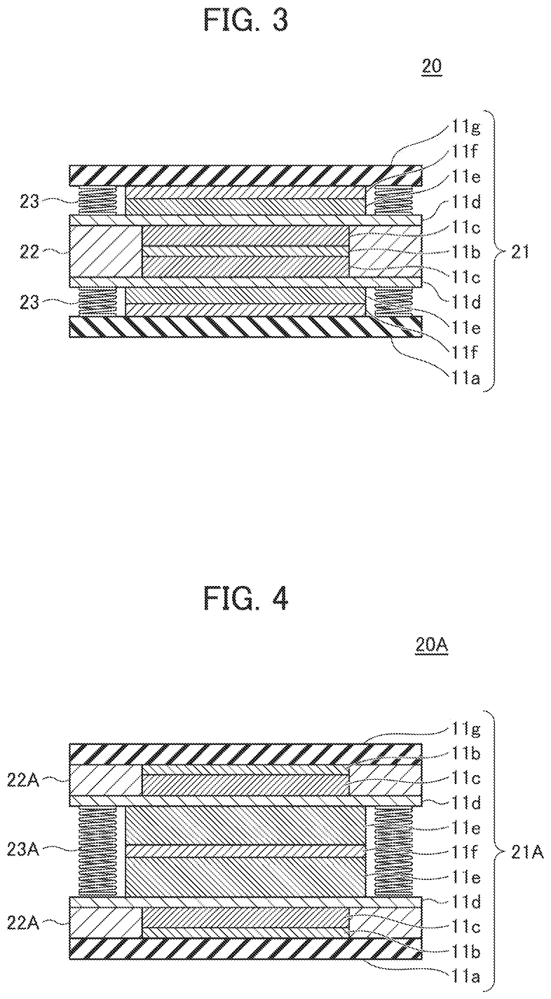

FIG. 3 illustrates another example of the solid-state battery according to the present embodiment.

The solid-state battery 20 includes an electrode laminate 21 in which a negative electrode current collector 11f, a negative electrode mixture layer 11e, a solid electrolyte layer 11d, a positive electrode mixture layer 11c, a positive electrode current collector 11b, a positive electrode mixture layer 11c, a solid electrolyte layer 11d, a negative electrode mixture layer 11e, a negative electrode current collector 11f, and a second fixing member 11g are sequentially laminated over a first fixing member 11a. Due to this configuration, even in a case of using a stack of the electrode laminates 21, the occurrence of stack displacement is prevented or reduced. The electrode laminate 21 is the same as the electrode laminate 11 except for a difference in the lamination structure. Here, a first guide member 22 is disposed along an outer periphery of the positive electrode mixture layer 11c, an outer periphery of the positive electrode current collector 11b, and an outer periphery of a positive electrode mixture layer 11c. Second guide members 23 are each disposed along an outer periphery of the corresponding negative electrode mixture layer 11e and an outer periphery of the corresponding negative electrode current collector 11f. Since the first guide member 22 is bonded to the solid electrolyte layers 11d arranged on both sides in the lamination direction of the electrode laminate 21, extension and displacement of the positive electrode (the positive electrode current collector 11b and the positive electrode mixture layers 11c) are prevented or reduced during the process for manufacturing the solid-state battery 20. Furthermore, since each second guide member 23 is bonded to the corresponding solid electrolyte layer 11d and the first fixing member 11a or the second fixing member 11g, extension and displacement of each negative electrode (the negative electrode current collector 11f and the negative electrode mixture layer 11e) are prevented or reduced during the process for manufacturing the solid-state battery 20.

In a case where the negative electrode mixture layers 11e are lithium metal layers, the negative electrode mixture layers 11e do not have to exist in an initial state. That is, the solid-state battery 20 may be configured as an anode-free battery.

Each second guide member 23 is an elastic member, and each of the first fixing member 11a, the second fixing member 11g, and the first guide member 22 is an elastic member having a higher Young's modulus than the second guide members 23. Therefore, even if the negative electrode mixture layers 11e expand and contract due to charge and discharge of the solid-state battery 20, displacement of the negative electrode mixture layers 11e is absorbed. Here, the Young's modulus of the first fixing member 11a, that of the second fixing member 11g, and that of the first guide member 22 are, for example, 500 MPa or more and less than 5000 MPa, whereas the Young's modulus of the second guide members 23 is, for example, 5 MPa or more and less than 500 MPa.

Elastic materials forming the first fixing member 11a, the second fixing member 11g, and the first guide member 22 are not particularly limited, and examples thereof include a nonwoven fabric, a solid electrolyte, etc.

The second guide members 23 are not particularly limited, and examples thereof include springs and the like.

FIG. 4 illustrates a modification of the solid-state battery 20.

The solid-state battery 20A has the same configuration as that of the solid-state battery 20 except that the arrangement of the positive electrode current collector 11b, the positive electrode mixture layers 11c, and the first guide member 22 is exchanged with the arrangement of the negative electrode current collector 11f, the negative electrode mixture layer 11e, and the second guide member 23. Specifically, in the electrode laminate 21A, a positive electrode current collector 11b, a positive electrode mixture layer 11c, a solid electrolyte layer 11d, a negative electrode mixture layer 11e, a negative electrode current collector 11f, a negative electrode mixture layer 11e, a solid electrolyte layer 11d, a positive electrode mixture layer 11c, a positive electrode current collector 11b, and a second fixing member 11g are sequentially laminated over a first fixing member 11a. A second guide member 23A is disposed along an outer periphery of each of the negative electrode mixture layers 11e and an outer periphery of the negative electrode current collector 11f. First guide members 22A are each disposed along an outer periphery of the corresponding positive electrode current collector 11b and an outer periphery of the corresponding positive electrode mixture layer 11c.

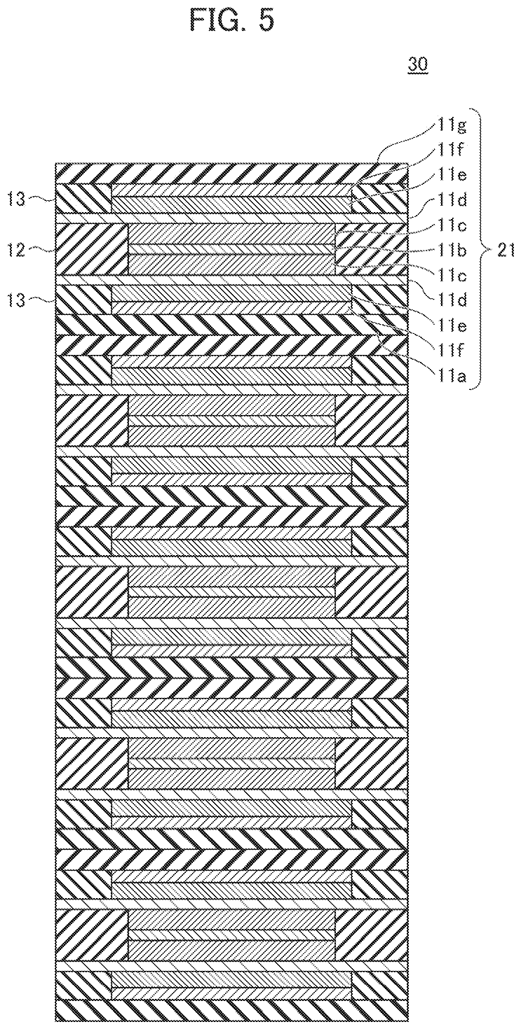

FIG. 5 illustrates another example of the solid-state battery according to the present embodiment.

The solid-state battery 30 is similar to the solid-state battery 20 except that a plurality of electrode laminates 21 are stacked, and first guide members 12 and second guide members 13 (see FIG. 1) are provided in place of the first guide members 22 and the second guide members 23.

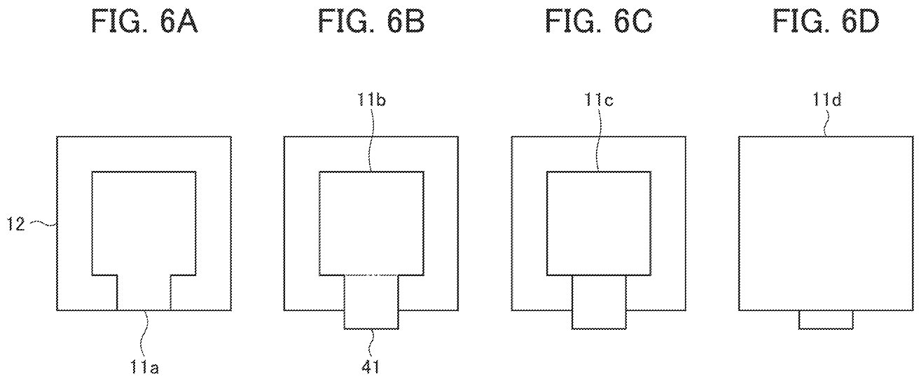

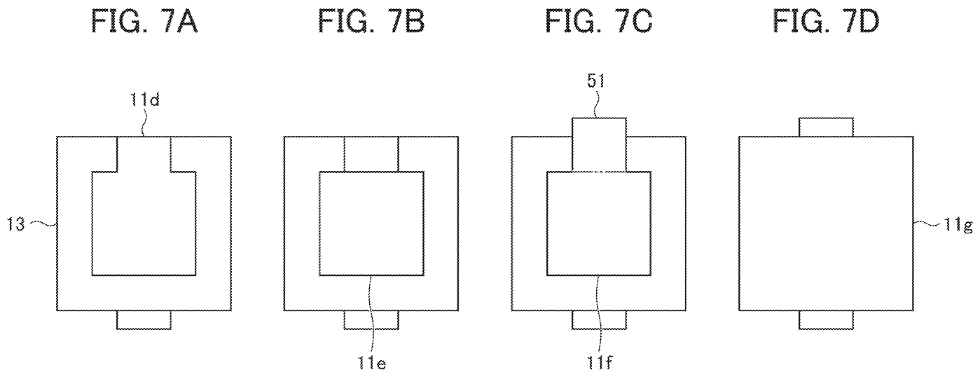

FIGS. 6 and 7 illustrate a method of manufacturing the solid-state battery 10 as an example of a method of manufacturing the solid-state battery according to the present embodiment.

The method of manufacturing the solid-state battery 10 includes a first disposing step of disposing the first guide member 12 (see FIG. 6A) on the first fixing member 11a, and a second disposing step of disposing the positive electrode current collector 11b (see FIG. 6B) and the positive electrode mixture layer 11c (see FIG. 6C) over a region of the first fixing member 11a where the first guide member 12 is not disposed. In the second disposing step, the positive electrode prepared in advance by forming the positive electrode mixture layer 11c on the positive electrode current collector 11b is used, but FIGS. 6B and 6C are shown in order to clarify the arrangement of the members constituting the positive electrode. Here, the first fixing member 11a, the positive electrode current collector 11b, and the positive electrode mixture layer 11c each have a rectangular shape. The positive electrode current collector 11b and the positive electrode mixture layer 11c have the same area, and a positive electrode tab 41 extends from the positive electrode current collector 11b. Furthermore, the first guide member 12 has an inner periphery that corresponds in shape to an outer periphery of the positive electrode current collector 11b and an outer periphery of the positive electrode tab 41.

The method of manufacturing the solid-state battery 10 may further include, between the first disposing step and the second disposing step, a temporary bonding step of temporarily bonding the first fixing member 11a to the first guide member 12. The temporary bonding method in the temporary bonding step is not particularly limited, and examples thereof include a pressure bonding method and the like.

The method of manufacturing the solid-state battery 10 further includes a third disposing step of disposing the solid electrolyte layer 11d (see FIG. 6D) on the first guide member 12 and the positive electrode mixture layer 11c, and a fourth disposing step of disposing the second guide member 13 (see FIG. 7A) on the solid electrolyte layer 11d. Here, the solid electrolyte layer 11d has a rectangular shape, and the first fixing member 11a and the solid electrolyte layer 11d have the same area.

The method of manufacturing the solid-state battery 10 may further include, between the third disposing step and the fourth disposing step, a temporary bonding step of temporarily bonding the first guide member 12 to the solid electrolyte layer 11d. The temporary bonding method in the temporary bonding step is not particularly limited, and examples thereof include a pressure bonding method and the like.

The method of manufacturing the solid-state battery 10 further includes a fifth disposing step of disposing the negative electrode mixture layer 11e (see FIG. 7B) and the negative electrode current collector 11f (see FIG. 7C) over a region of the solid electrolyte layer 11d where the second guide member 13 is not disposed. In the fifth disposing step, the negative electrode prepared in advance by forming the negative electrode mixture layer 11e on the negative electrode current collector 11f is used, but FIGS. 7B and 7C are shown in order to clarify the arrangement of the members constituting the negative electrode. Here, the negative electrode mixture layer 11e and the negative electrode current collector 11f each have a rectangular shape. The negative electrode mixture layer 11e and the negative electrode current collector 11f have the same area, and a negative electrode tab 51 extends from the negative electrode current collector 11f. Furthermore, the second guide member 13 has an inner periphery that corresponds in shape to an outer periphery of the negative electrode mixture layer 11e and an outer periphery of the negative electrode current collector 11f.

The method of manufacturing the solid-state battery 10 may further include, between the fourth disposing step and the fifth disposing step, a temporary bonding step of temporarily bonding the solid electrolyte layer 11d to the second guide member 13. The temporary bonding method in the temporary bonding step is not particularly limited, and examples thereof include a pressure bonding method and the like.

The method of manufacturing the solid-state battery 10 further includes a sixth disposing step of disposing the second fixing member 11g (see FIG. 7D) on the second guide member 13 and the negative electrode mixture layer 11e, and a bonding step of bonding the first guide member 12 to the first fixing member 11a and the solid electrolyte layer 11d and bonding the second guide member 13 to the solid electrolyte layer 11d and the second fixing member 11g. Here, the second fixing member 11g has a rectangular shape, and the second fixing member 11g and the solid electrolyte layer 11d have the same area. The bonding method in the bonding step is not particularly limited, and examples thereof include a pressure bonding method and the like.

The solid-state battery 10A can be manufactured in the same manner as for the solid-state battery 10 except that the order of the third disposing step and the fourth disposing step is reversed.

The solid-state batteries 20 and 30 can be manufactured in the same manner as for the solid-state battery 10. Here, it is possible to manufacture the solid-state batteries 20 and 30 by stacking three members prepared in advance in the following manner. First, one member is prepared in which a negative electrode current collector 11f and a negative electrode mixture layer 11e are sequentially laminated over a first fixing member 11a, and in which a second guide member 23 is disposed along an outer periphery of the negative electrode current collector 11f and an outer periphery of the negative electrode mixture layer 11e. In a similar manner, another member is prepared in which a negative electrode current collector 11f and a negative electrode mixture layer 11e are sequentially laminated over a second fixing member 11g, and in which a second guide member 23 is disposed along an outer periphery of the negative electrode current collector 11f and an outer periphery of the negative electrode mixture layer 11e. The other member is prepared in which a positive electrode mixture layer 11c, a positive electrode current collector 11b, a positive electrode mixture layer 11c, and a solid electrolyte layer 11d are sequentially laminated over a solid electrolyte layer 11d, and in which a first guide member 22 is disposed along an outer periphery of the positive electrode mixture layer 11c, an outer periphery of the positive electrode current collector 11b, and an outer periphery of the positive electrode mixture layer 11c.

The solid-state battery 20A can be manufactured in the same manner as for the solid-state battery 20 except that the arrangement of the positive electrode current collector 11b, the positive electrode mixture layer 11c, and the first guide member 22 is exchanged with the arrangement of the negative electrode current collector 11f, the negative electrode mixture layer 11e, and the second guide member 23.

In the following, a case where the solid-state battery of the present embodiment is an all-solid-state lithium secondary battery will be described.

The positive electrode current collector is not particularly limited, and examples thereof include an aluminum foil and the like.

The positive electrode mixture layer contains a positive electrode active material, and may further contain a solid electrolyte, a conductive auxiliary agent, a binder, and the like.

The positive electrode active material is not limited to any particular material as long as the positive electrode active material is capable of occluding and releasing lithium ions, and examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LifePO₄, lithium sulfide, sulfur, and the like.

The solid electrolyte layer is obtained, for example, by impregnating a nonwoven fabric with a solid electrolyte.

The solid electrolyte is not particularly limited as long as the solid electrolyte is capable of conducting lithium ions, and examples thereof include an oxide electrolyte, a sulfide electrolyte, etc.

The negative electrode mixture layer contains a negative electrode active material, and may further contain a solid electrolyte, a conductive auxiliary agent, a binder, and the like.

The negative electrode active material is not particularly limited as long as the negative electrode active material is capable of occluding and releasing lithium ions, and examples thereof include metallic lithium, a lithium alloy, a metal oxide, a metal sulfide, a metal nitride, Si, SiO, a carbon material, etc. Examples of the carbon material include artificial graphite, natural graphite, hard carbon, soft carbon, etc.

The negative electrode current collector is not particularly limited, and examples thereof include a copper foil and the like.

It should be noted that the present invention is not limited to the embodiments described above, and the embodiments described above may be appropriately modified without deviating from the spirit of the present invention.

### EXPLANATION OF REFERENCE NUMERALS

10, 10A, 20, 20A, 30: Solid-state battery
11, 11A, 21, 21A: Electrode laminate
11a: First fixing member
11b: Positive electrode current collector
11c: Positive electrode mixture layer
11d: Solid electrolyte layer
11e: Negative electrode mixture layer
11f: Negative electrode current collector
11g: Second fixing member
12, 22, 22A: First guide member
13, 13A, 23, 23A: Second guide member
41: Positive electrode tab
51: Negative electrode tab

What is claimed is:

1. A solid-state battery comprising:
an electrode laminate in which a first electrode mixture layer, a solid electrolyte layer, a second electrode mixture layer, and a second fixing member are sequentially laminated over a first fixing member;
a first guide member disposed along an outer periphery of the first electrode mixture layer; and
a second guide member disposed along an outer periphery of the second electrode mixture layer,
the first guide member being bonded to the solid electrolyte layer and/or the first fixing member,
the second guide member being bonded to the solid electrolyte layer and/or the second fixing member.

2. The solid-state battery according to claim 1, wherein
at least one of the solid electrolyte layer, the first fixing member, the second fixing member, the first guide member, or the second guide member includes a nonwoven fabric,
a content of the nonwoven fabric in the solid electrolyte layer is equal to or less than a content of the nonwoven fabric in the first fixing member, equal to or less than a content of the nonwoven fabric in the second fixing member, equal to or less than a content of the nonwoven fabric in the first guide member, and equal to or less than a content of the nonwoven fabric in the second guide member, and
an average fiber diameter of the nonwoven fabric in the solid electrolyte layer is equal to or less than an average fiber diameter of the nonwoven fabric in the first fixing member, equal to or less than an average fiber diameter of the nonwoven fabric in the second fixing member, equal to or less than an average fiber diameter of the nonwoven fabric in the first guide member, and equal to or less than an average fiber diameter of the nonwoven fabric in the second guide member.

3. The solid-state battery according to claim 1, wherein
the solid electrolyte layer, the first fixing member, the second fixing member, the first guide member, and the second guide member each include a binder, and
a content of the binder in the solid electrolyte layer is equal to or less than a content of the binder in the first fixing member, equal to or less than a content of the binder in the second fixing member, equal to or less than a content of the binder in the first guide member, and equal to or less than a content of the binder in the second guide member.

4. The solid-state battery according to claim 1, wherein
the first electrode mixture layer and the second electrode mixture layer are a positive electrode mixture layer and a negative electrode mixture layer, respectively,
the second guide member is an elastic member, and
each of the first fixing member, the second fixing member, and the first guide member is an elastic member having a higher Young's modulus than the second guide member.

5. A method of manufacturing the solid-state battery according to claim 1, the method comprising:
a first disposing step of disposing the first guide member on the first fixing member;
a second disposing step of disposing the first electrode mixture layer over a region of the first fixing member where the first guide member is not disposed;
a third disposing step of disposing the solid electrolyte layer on the first guide member and the first electrode mixture layer;
a fourth disposing step of disposing the second guide member on the solid electrolyte layer;
a fifth disposing step of disposing the second electrode mixture layer over a region of the solid electrolyte layer where the second guide member is not disposed;
a sixth disposing step of disposing the second fixing member on the second guide member and the second electrode mixture layer; and
a bonding step of bonding the first guide member to the solid electrolyte layer and/or the first fixing member and bonding the second guide member to the solid electrolyte layer and/or the second fixing member.

6. The method according to claim 5, further comprising:
a temporary bonding step of temporarily bonding the first fixing member to the first guide member, between the first disposing step and the second disposing step.

7. The method according to claim 5, further comprising:
a temporary bonding step of temporarily bonding the first guide member to the solid electrolyte layer, between the third disposing step and the fourth disposing step.

8. The method according to claim 5, further comprising:
a temporary bonding step of temporarily bonding the solid electrolyte layer to the second guide member, between the fourth disposing step and the fifth disposing step.
